(19) United States
(12) Patent Application Publication
(10) Pub. No.: US 2013/0063352 A1
(43) Pub. Date: Mar. 14, 2013

(54) COMPUTER PERIPHERAL DEVICE AND METHOD FOR CONTROLLING SCROLL BARS IN DIFFERENT WINDOWS

(71) Applicants: Yi-Guang Chen, Taipei (TW); Chien-Nan Lin, Taipei (TW)

(72) Inventors: Yi-Guang Chen, Taipei (TW); Chien-Nan Lin, Taipei (TW)

(73) Assignee: PRIMAX ELECTRONICS LTD., Taipei (TW)

(21) Appl. No.: 13/364,986

(22) Filed: Feb. 2, 2012

(30) Foreign Application Priority Data
Sep. 9, 2011 (TW) 100132566

(51) Int. Cl. G06F 3/033; G06F 3/041; G06F 3/01

(52) U.S. Cl. 345/163; 345/156; 345/173

(57) ABSTRACT

A computer peripheral device for controlling scroll bars in different windows is provided. The computer peripheral device includes a plurality of scroll bar controlling units and a signal processing unit. These scroll bar controlling units are used for generating a scroll bar controlling signal. The signal processing unit is used for analyzing the scroll bar controlling signal. According to the scroll bar controlling signal, the scroll bars in different windows are correspondingly controlled. A method for controlling scroll bars in different windows is also provided. Firstly, the signal source of the scroll bar controlling signal is analyzed. According to the signal source, the scroll bars in different windows are correspondingly controlled. Consequently, the speed of switching different windows is increased, and the working efficiency is enhanced.

### FIELD OF THE INVENTION

The present invention relates to a computer peripheral device and a method for controlling scroll bars, and more particularly to a computer peripheral device and a method for controlling scroll bars in different windows.

### BACKGROUND OF THE INVENTION

For facilitating the user to read a lot of information, the graphic-based interface is usually equipped with a scroll bar. By scrolling the scroll bar, the information displayed on the screen is correspondingly changed. For complying with the scrolling function, a variety of computer peripheral devices have been disclosed. For example, a conventional wheel mouse is one of these computer peripheral devices. Generally, the conventional wheel mouse has a single ordinary wheel for controlling the scroll bar of the wheel. Nowadays, a mouse equipped with a four-directional wheel or two ordinary wheels is provided. However, such a mouse is only able to control different scroll bars (e.g. a vertical scroll bar and a horizontal scroll bar) of the same window.

FIG. 1 schematically illustrates the connection between a conventional mouse and a computer. As shown in FIG. 1, the mouse 10 has a wheel 11, and the computer 20 has a monitor 21. The monitor 21 is used for displaying a first window 22, a second window 23 and a cursor 24. The first window 22 has a scroll bar 220. The second window 23 has a scroll bar 230. By operating the wheel 11 of the conventional mouse 10, the scroll bar 220 of the first window 22 or the scroll bar 230 of the second window 23 can be selectively scrolled.

For example, when the user performs a word processing task by operating the second window 23, the user may operate the wheel 11 of the mouse 10 to control the scroll bar 230 of the second window 23. If the user wants to refer to the information of the first window 22 and scroll the scroll bar 220 of the first window 22, the user needs to move the conventional mouse 10 to have the cursor 24 move to the first window 22 and then click the first window 22. In such way, the user can operate the wheel 11 of the mouse 10 to control the scroll bar 220 of the first window 22.

After the information of the first window 22 is acquired, the user should move the mouse 10 to have the cursor move to the second window 23 and then click the second window 23. Consequently, the user can continuously operate the second window 23 to perform the word processing task. However, if the word processing task is frequently performed by the user, the conventional way of scrolling the scroll bars in different windows is very inconvenient to the user. In other words, the working efficiency is deteriorated.

### SUMMARY OF THE INVENTION

The present invention provides a computer peripheral device and a method for controlling scroll bars in different windows in order to increase the efficiency of controlling the scroll bars in different windows.

In accordance with an aspect of the present invention, there is provided a computer peripheral device for controlling scroll bars in different windows. The computer peripheral device includes a plurality of scroll bar controlling units and a signal processing unit. The scroll bar controlling units are installed in the computer peripheral device, and includes a first scroll bar controlling unit and a second scroll bar controlling unit for generating a scroll bar controlling signal. The signal processing unit is used for analyzing the scroll bar controlling signal. If the scroll bar controlling signal is generated by the first scroll bar controlling unit, a scroll bar of a window is controlled according to the scroll bar controlling signal. Wherein, if the scroll bar controlling signal is generated by the second scroll bar controlling unit, a scroll bar of another window is controlled according to the scroll bar controlling signal.

In an embodiment, the computer peripheral device is a mouse.

In an embodiment, the first scroll bar controlling unit is a first wheel, and the second scroll bar controlling unit is a second wheel.

In an embodiment, the first scroll bar controlling unit is a first sensing area, and the second scroll bar controlling unit is a second sensing area.

In an embodiment, the first sensing area is disposed on a first touchpad, and the second sensing area is disposed on a second touchpad.

In an embodiment, the first sensing area and the second sensing area are both disposed on a touchpad.

In an embodiment, the scroll bar controlling signal contains a local information, and the local information of the scroll bar controlling signal is analyzed by the signal processing unit. If the local information complies with a first local information corresponding to the first sensing area, the signal processing unit judges that the scroll bar controlling signal is generated by the first sensing area. Whereas, if the local information complies with a second local information corresponding to the second sensing area, the signal processing unit judges that the scroll bar controlling signal is generated by the second sensing area.

In an embodiment, the local information is a coordinate.

In an embodiment, the first local information is a first coordinate range, and the second local information is a second coordinate range.

In an embodiment, the first sensing area and the second sensing area includes a plurality of sensing units, wherein each of the sensing units has a sensing unit code, and the local information is the sensing unit code.

In an embodiment, the first local information is a first sensing unit code range, and the second local information is a second sensing unit code range.

In accordance with another aspect of the present invention, there is provided a method for controlling scroll bars in different windows by operating a computer peripheral device. The computer peripheral device includes a plurality of scroll bar controlling units. The scroll bar controlling units includes a first scroll bar controlling unit and a second scroll bar controlling unit for generating a scroll bar controlling signal. The method includes the following steps. Firstly, the scroll bar controlling signal is analyzed, so that a signal source is generated, wherein the signal source is one of the plurality of scroll bar controlling units. Then, a judging step is performed to judge whether the signal source complies with a preset signal source or not. If the signal source complies with the preset signal source, the scroll bar controlling signal is transmitted. Whereas, if the signal source does not comply with the preset signal source, a window switching signal and the scroll bar controlling signal are transmitted. Afterwards, the signal source is recorded, and the signal source is set as the preset signal source.

In an embodiment, the computer peripheral device is a mouse.

In an embodiment, the preset signal source is the first scroll bar controlling unit.

In an embodiment, the first scroll bar controlling unit is a first wheel, and the second scroll bar controlling unit is a second wheel.

In an embodiment, the first scroll bar controlling unit is a first sensing area, and the second scroll bar controlling unit is a second sensing area.

In an embodiment, the first sensing area is disposed on a first touchpad, and the second sensing area is disposed on a second touchpad.

In an embodiment, the first sensing area and the second sensing area are both disposed on a touchpad.

In an embodiment, in the step (A), the signal source is realized according to a local information of the scroll bar controlling signal. If the local information complies with a first local information corresponding to the first sensing area, the signal processing unit judges that the scroll bar controlling signal is generated by the first sensing area. Whereas, if the local information complies with a second local information corresponding to the second sensing area, the signal processing unit judges that the scroll bar controlling signal is generated by the second sensing area.

In an embodiment, the local information is a coordinate.

In an embodiment, the first local information is a first coordinate range, and the second local information is a second coordinate range.

In an embodiment, the first sensing area and the second sensing area includes a plurality of sensing units, wherein each of the sensing units has a sensing unit code, and the local information is the sensing unit code.

In an embodiment, the first local information is a first sensing unit code range, and the second local information is a second sensing unit code range.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the connection between a conventional mouse and a computer;

FIG. 2 is a schematic functional block diagram illustrating a mouse according to a first embodiment of the present invention;

FIG. 3 schematically illustrates the connection between the mouse of FIG. 2 and a computer;

FIG. 4 is a flowchart illustrating a method for controlling scroll bars in different windows according to a first embodiment of the present invention;

FIG. 5 is a schematic functional block diagram illustrating a mouse according to a second embodiment of the present invention;

FIG. 6 is a schematic functional block diagram illustrating a mouse according to a third embodiment of the present invention;

FIG. 7 schematically illustrates the connection between the mouse of FIG. 6 and a computer;

FIG. 8 schematically illustrates the first sensing area and the second sensing area of the mouse according to the third embodiment of the present invention; and

FIG. 9 is a flowchart illustrating a method for controlling scroll bars in different windows according to the third embodiment of the present invention.

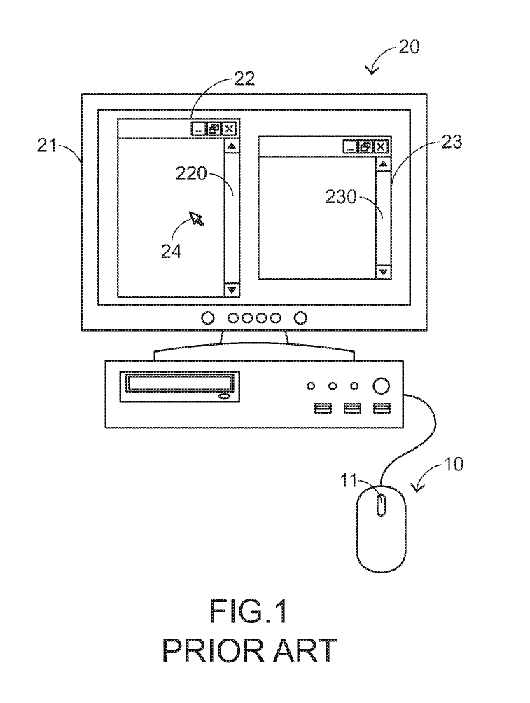

### DETAILED DESCRIPTION OF THE PREFERRED EMBODIMENT

In the present invention, the computer peripheral device includes for example a mouse, a keyboard, a touch device or any other known input device for the computer. Hereinafter, the present invention will be illustrated by referring to a mouse as a computer peripheral device.

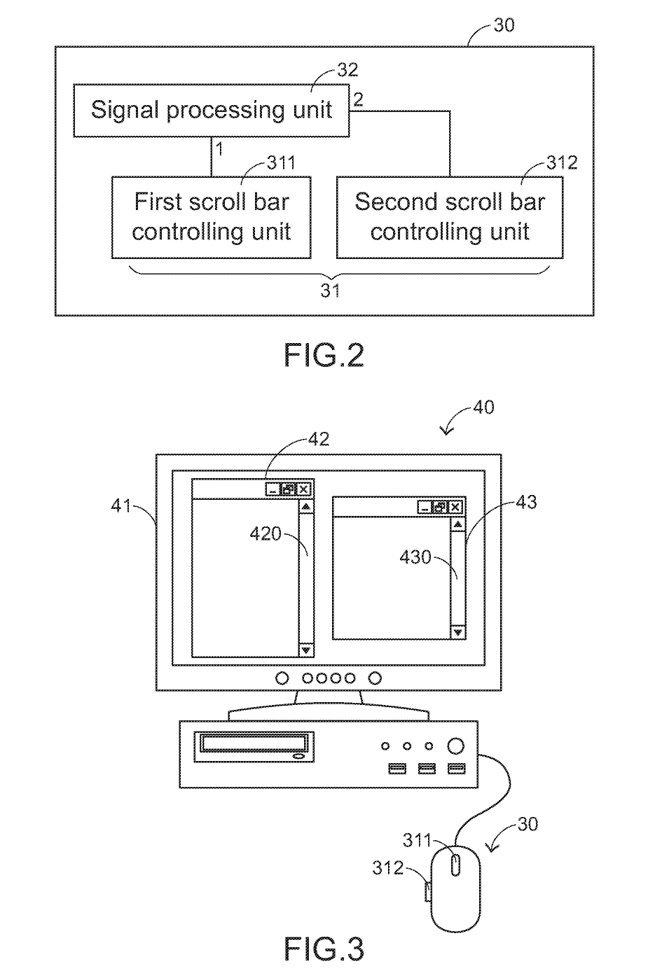

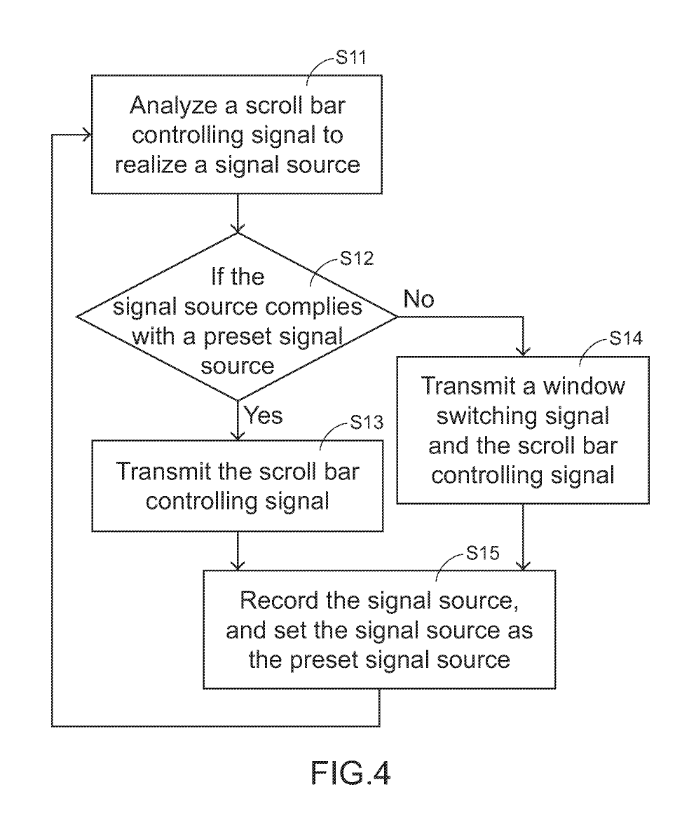

FIG. 2 is a schematic functional block diagram illustrating a mouse according to a first embodiment of the present invention. FIG. 3 schematically illustrates the connection between the mouse of FIG. 2 and a computer.

Please refer to FIGS. 2 and 3. The mouse 30 has a plurality of scroll bar controlling units 31 and a signal processing unit 32. In this embodiment, the scroll bar controlling units 31 comprises a first scroll bar controlling unit 311 and a second scroll bar controlling unit 312. The computer 40 has a monitor 41 for displaying a window 42 and another window 43. In this embodiment, the window 42 is a current window, and the window 43 is a next lower-level window relative to the window 42.

Moreover, according to the settings under a Microsoft Windows series operating system, a window switching signal is generated by pressing the shortcut Alt-Tab. Once the window switching signal is received by the computer 40, the hierarchical relationship between the window 42 and the window 43 is switched. Consequently, the window 43 is considered as the current window, and the window 42 is switched to be a next lower-level window relative to the window 43. The windows 42 and 43 shown on the monitor 41 are distributed in a non-overlapped manner, a partially overlapped manner or a completely overlapped manner. Moreover, the window 42 has a scroll bar 420, and the window 43 has a scroll bar 430.

The first scroll bar controlling unit 311 and the second scroll bar controlling unit 312 are electrically connected with the signal processing unit 32 through different pins, respectively. As shown in FIG. 2, the first scroll bar controlling unit 311 is electrically connected with the signal processing unit 32 through the pin 1, and the second scroll bar controlling unit 312 is electrically connected with the signal processing unit 32 through the pin 2.

Each of scroll bar controlling units 31 of the mouse 30 is used for generating a scroll bar controlling signal. According to the scroll bar controlling signal, the movement of the scroll bar of the current window is correspondingly controlled. The signal processing unit 32 is used for analyzing the scroll bar controlling signal. If the signal processing unit 32 judges that the scroll bar controlling signal is generated by the first scroll bar controlling unit 311, the window 42 is considered as a current window. Consequently, the scroll bar 420 of the window 42 is controlled according to the scroll bar controlling signal. Whereas, if the signal processing unit 32 judges that the scroll bar controlling signal is generated by the second scroll bar controlling unit 312, the window 43 is switched to be the current window. Consequently, the scroll bar 430 of the window 43 is controlled according to the scroll bar controlling signal. The ways of analyzing the scroll bar controlling signal and switching the windows will be illustrated in more details as follows.

In this embodiment, the first scroll bar controlling unit 311 and the second scroll bar controlling unit 312 are installed on the mouse 30. Especially, the first scroll bar controlling unit 311 and the second scroll bar controlling unit 312 are a first wheel and a second wheel, respectively.

Hereinafter, a method of analyzing the scroll bar controlling signal and switching the windows by the signal processing unit 32 will be illustrated.

FIG. 4 is a flowchart illustrating a method for controlling scroll bars in different windows according to a first embodiment of the present invention. Firstly, in the step S11, the signal processing unit 32 realizes a signal source by analyzing the scroll bar controlling signal. The signal source is one of the scroll bar controlling units 31.

In this embodiment, the signal processing unit 32 analyzes the signal source according to the pin which the scroll bar controlling signal is inputted into. For example, if the scroll bar controlling signal is inputted into the signal processing unit 32 through the pin 1, it means that the signal source of the scroll bar controlling signal is the first scroll bar controlling unit 311. Whereas, if the scroll bar controlling signal is inputted into the signal processing unit 32 through the pin 2, it means that the signal source of the scroll bar controlling signal is the second scroll bar controlling unit 312.

Then, in the step S12, the signal processing unit 32 judges whether the signal source complies with a preset signal source or not. The preset signal source is a criterion for judging whether a window switching signal is transmitted or not. The first scroll bar controlling unit 311 may be preset as the preset signal source by a manufacturer of the mouse 30. Alternatively, any of the scroll bar controlling units 31 may be preset as the preset signal source by the user. Once the window switching signal is received by the computer 40, the hierarchical relationship between the window 42 and the window 43 is switched. Consequently, the window 43 is considered as the current window, and the window 42 is a next lower-level window relative to the window 43. In this embodiment, the first scroll bar controlling unit 311 is preset as the preset signal source. It is noted that the preset signal source is not limited to the first scroll bar controlling unit 311.

If the signal source complies with the preset signal source (i.e. the first scroll bar controlling unit 311), the step S13 is done. In the step S13, the scroll bar controlling signal is transmitted from the signal processing unit 32 to the computer 40. According to the scroll bar controlling signal, the scroll bar 420 of the current window (i.e. the window 42) is correspondingly controlled, and then the step S15 is done. On the other hand, if the signal source does not comply with the preset signal source (i.e. the signal source is the second scroll bar controlling unit 312), the step S14 is done. In the step S14, a window switching signal and the scroll bar controlling signal are transmitted from the signal processing unit 32 to the computer 40, and then the step S15 is done.

After the window switching signal is received by the computer 40, the hierarchical relationship between the window 42 and the window 43 is switched. Meanwhile, the window 43 is considered as the current window. According to the scroll bar controlling signal, the scroll bar 430 of the current window (i.e. the window 43) is correspondingly controlled. Consequently, the purpose of controlling scroll bars in different windows is achieved.

Then, in the step S15, the signal source of the scroll bar controlling signal is recorded by the signal processing unit 32, and the signal source is set as the preset signal source. Then, the step S 11 is repeatedly done. That is, if the signal source is the first scroll bar controlling unit 311, the preset signal source is also the first scroll bar controlling unit 311. Whereas, if the signal source is the second scroll bar controlling unit 312, the preset signal source is changed to the second scroll bar controlling unit 312.

After the step S15 is performed, the analyzing sample of the next scroll bar controlling signal is provided. If the signal source of the next scroll bar controlling signal is not changed, the signal source complies with the preset signal source. Meanwhile, the signal processing unit 32 needs to issue only the scroll bar controlling signal to the computer 40. Consequently, the scroll bar of the same window is continuously controlled. On the other hand, if the signal source of the next scroll bar controlling signal is changed, the signal source fails to comply with the preset signal source. Meanwhile, the signal processing unit 32 needs to issue the window switching signal and the scroll bar controlling signal to the computer 40. Consequently, the purpose of controlling scroll bars in different windows is achieved.

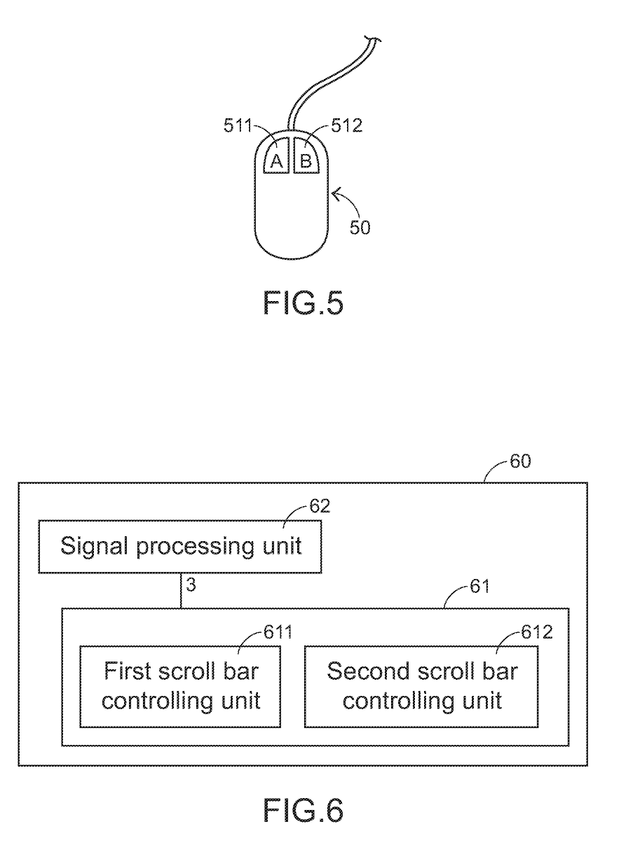

FIG. 5 is a schematic functional block diagram illustrating a mouse according to a second embodiment of the present invention. As shown in FIG. 5, the mouse 50 comprises first scroll bar controlling unit 511 and a second scroll bar controlling unit 512.

Except that the first scroll bar controlling unit 511 and the second scroll bar controlling unit 512 are respectively a first sensing area A and a second sensing area B, the other components of the mouse of the second embodiment are similar to those of the first embodiment of FIG. 3, and are not redundantly described herein. Moreover, the first sensing area A is disposed on a first touchpad, and the second sensing area B is disposed on a second touchpad. Each of the first touchpad and the second touchpad is for example a conventional resistive touchpad, a conventional capacitive touchpad or any other touchpad complying with the touch technique.

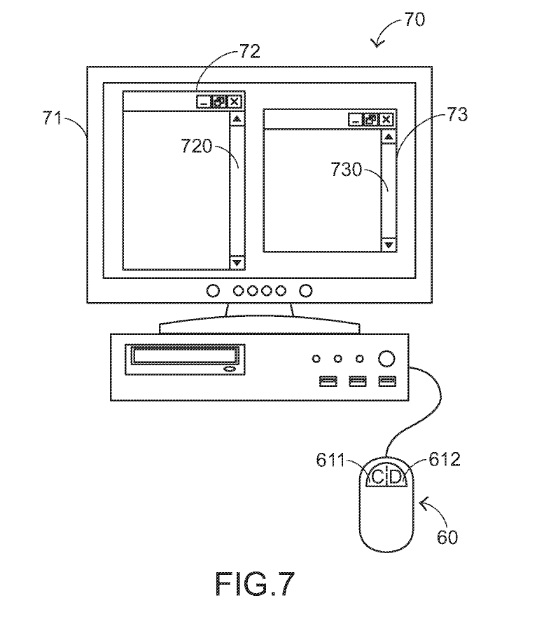

FIG. 6 is a schematic functional block diagram illustrating a mouse according to a third embodiment of the present invention. FIG. 7 schematically illustrates the connection between the mouse of FIG. 6 and a computer.

Please refer to FIGS. 6 and 7. The mouse 60 has a plurality of scroll bar controlling units 61 and a signal processing unit 62. In this embodiment, the scroll bar controlling units 61 comprises a first scroll bar controlling unit 611 and a second scroll bar controlling unit 612. The computer 70 has a monitor 71 for displaying a window 72 and another window 73. In this embodiment, the window 72 is a current window, and the window 73 is a next lower-level window relative to the window 72.

Moreover, according to the settings under a Microsoft Windows series operating system, a window switching signal is generated by pressing the shortcut Alt-Tab. Once the window switching signal is received by the computer 70, the hierarchical relationship between the window 72 and the window 73 is switched. Consequently, the window 73 is considered as the current window, and the window 72 is switched to be a next lower-level window relative to the window 73. The windows 72 and 73 shown on the monitor 71 are distributed in a non-overlapped manner, a partially overlapped manner or a completely overlapped manner. Moreover, the window 72 has a scroll bar 720, and the window 73 has a scroll bar 730.

As shown in FIG. 6, the first scroll bar controlling unit 611 is electrically connected with the signal processing unit 62 through the pin 3, and the second scroll bar controlling unit 612 is electrically connected with the signal processing unit 62 through the same pin 3.

Each of scroll bar controlling units 61 of the mouse 60 is used for generating a scroll bar controlling signal. According to the scroll bar controlling signal, the scrolling motion of the scroll bar of the current window is correspondingly controlled. The signal processing unit 62 is used for analyzing the scroll bar controlling signal. If the signal processing unit 62 judges that the scroll bar controlling signal is generated by the first scroll bar controlling unit 611, the window 72 is considered as a current window. Consequently, the scroll bar 720 of the window 72 is controlled according to the scroll bar controlling signal. Whereas, if the signal processing unit 72 judges that the scroll bar controlling signal is generated by the second scroll bar controlling unit 612, the window 73 is considered as the current window. Consequently, the scroll bar 730 of the window 73 is controlled according to the scroll bar controlling signal. The ways of analyzing the scroll bar controlling signal and switching the windows will be illustrated in more details as follows.

In this embodiment, the first scroll bar controlling unit 611 and the second scroll bar controlling unit 612 are disposed on a surface of the mouse 60. Especially, the first scroll bar controlling unit 611 and the second scroll bar controlling unit 612 are a first sensing area C and a second sensing area D, respectively. The first sensing area C and the second sensing area D are disposed on a touchpad.

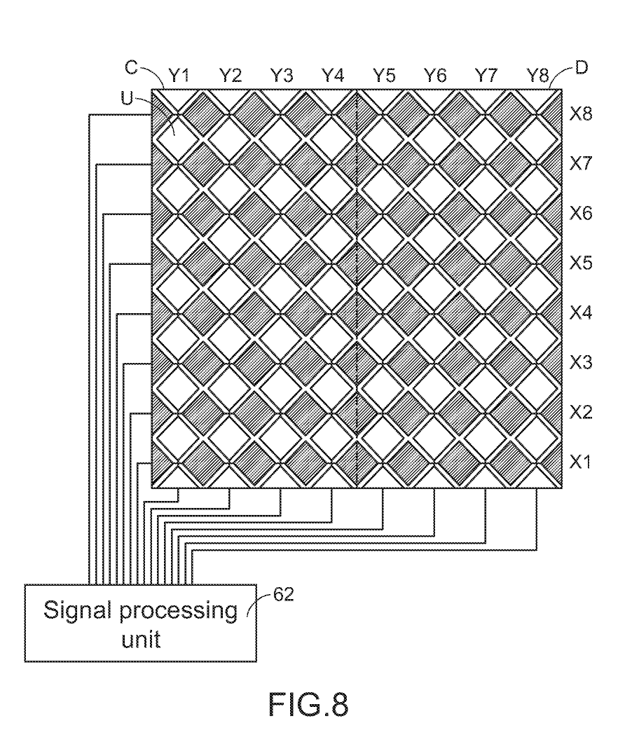

FIG. 8 schematically illustrates the first sensing area and the second sensing area of the mouse according to the third embodiment of the present invention. As shown in FIG. 8, the first sensing area C and the second sensing area D have a plurality of sensing units U. The touchpad is for example a conventional resistive touchpad, a conventional capacitive touchpad or any other touchpad complying with the touch technique. In this embodiment, the touchpad is illustrated by referring to the capacitive touchpad for illustration. As shown in FIG. 8, the touchpad comprises a plurality of conductive wires. The horizontal conductive wires X1˜X8 are arranged along the X direction. The vertical conductive wires Y1˜Y8 are arranged along the Y direction.

Hereinafter, a method of analyzing the scroll bar controlling signal and switching the windows by the signal processing unit 62 will be illustrated.

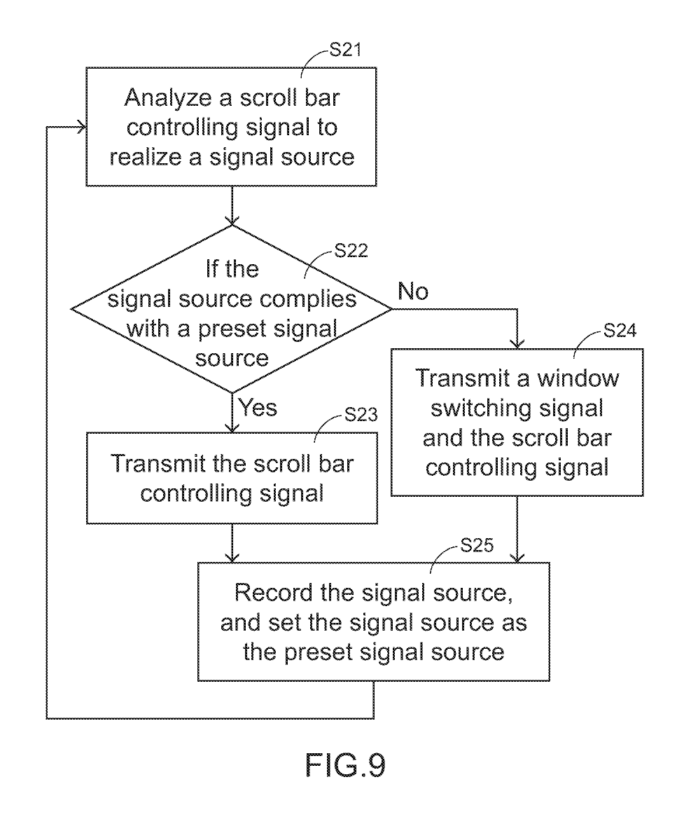

FIG. 9 is a flowchart illustrating a method for controlling scroll bars in different windows according to the third embodiment of the present invention. Firstly, in the step S21, the signal processing unit 62 realizes a signal source by analyzing the scroll bar controlling signal. The signal source is one of the scroll bar controlling units 61.

In this embodiment, the signal processing unit 62 analyzes the signal source according to a local information of the scroll bar controlling signal. For example, if the local information of the scroll bar controlling signal complies with a first local information corresponding to the first scroll bar controlling unit 611, it means that the source signal of the scroll bar controlling signal is the first scroll bar controlling unit 611. On the other hand, if the local information of the scroll bar controlling signal complies with a second local information corresponding to the second scroll bar controlling unit 612, it means that the source signal of the scroll bar controlling signal is the second scroll bar controlling unit 612.

In this embodiment, the local information indicates a position coordinate of a position of the first touchpad or the second touchpad that is touched by a user's finger or a stylus. Moreover, the position coordinate is acquired by detecting the horizontal conductive wires X1˜X8 and the vertical conductive wires Y1˜Y8. The way of acquiring the position coordinate is similar to that of the conventional touch technology, and is not redundantly described herein. In this embodiment, the first local information is preset to be a first coordinate range, and the second local information is preset to be a second coordinate range.

The local information is not limited to the coordinate range of the sensing area. For example, the local information may be the sensing unit code 0×n of the sensing unit U, wherein n=1, 2, . . . , n and n is a positive integer. In an embodiment, the preset sensing unit code is defined according to the preset code 0×n of the sequence of arranging the sensing unit U. That is, the position of each sensing unit U is defined according to preset sensing unit code. After a scroll bar controlling signal is generated, the sensing unit code 0×n corresponding to the triggered sensing unit U is realized by the signal processing unit 62 according to a look-up table. For example, the first local information is preset to be a first sensing unit code range from 0×01˜0×32, and the second local information is preset to be a second sensing unit code range from 0×33˜0×64.

Then, in the step S22, the signal processing unit 62 judges whether the signal source complies with a preset signal source or not. The preset signal source is a criterion for judging whether a window switching signal is transmitted or not. The first scroll bar controlling unit 611 may be preset as the preset signal source by a manufacturer of the mouse 60. Alternatively, any of the scroll bar controlling units 31 may be preset as the preset signal source by the user. Once the window switching signal is received by the computer 70, the hierarchical relationship between the window 72 and the window 73 is switched. Consequently, the window 73 is considered as the current window, and the window 72 is a next lower-level window relative to the window 73. In this embodiment, the first scroll bar controlling unit 611 is preset as the preset signal source. It is noted that the preset signal source is not limited to the first scroll bar controlling unit 611.

If the signal source complies with the preset signal source (i.e. the first scroll bar controlling unit 611), the step S23 is done. In the step S23, the scroll bar controlling signal is transmitted from the signal processing unit 62 to the computer 70. According to the scroll bar controlling signal, the scroll bar 720 of the current window (i.e. the window 72) is correspondingly controlled, and then the step S25 is done. On the other hand, if the signal source does not comply with the preset signal source (i.e. the signal source is the second scroll bar controlling unit 612), the step S24 is done. In the step S24, a window switching signal and the scroll bar controlling signal are transmitted from the signal processing unit 62 to the computer 70, and then the step S25 is done. After the window switching signal is received by the computer 70, the hierarchical relationship between the window 72 and the window 73 is switched. Meanwhile, the window 73 is considered as the current window. According to the scroll bar controlling signal, the scroll bar 730 of the current window (i.e. the window 73) is correspondingly controlled. Consequently, the purpose of controlling scroll bars in different windows is achieved.

Then, in the step S25, the signal source of the scroll bar controlling signal is recorded by the signal processing unit 62, and the signal source is set as the preset signal source. Then, the step S21 is repeatedly done. That is, if the signal source is the first scroll bar controlling unit 611, the preset signal source is also the first scroll bar controlling unit 611. Whereas, if the signal source is the second scroll bar controlling unit 612, the preset signal source is changed to the second scroll bar controlling unit 612.

After the step S25 is performed, the analyzing sample of the next scroll bar controlling signal is provided. If the signal source of the next scroll bar controlling signal is not changed, the signal source complies with the preset signal source. Meanwhile, the signal processing unit 62 needs to issue only the scroll bar controlling signal to the computer 70. Consequently, the scroll bar of the same window is continuously controlled. On the other hand, if the signal source of the next scroll bar controlling signal is changed, the signal source fails to comply with the preset signal source. Meanwhile, the signal processing unit 62 needs to issue the window switching signal and the scroll bar controlling signal to the computer 70. Consequently, the purpose of controlling scroll bars in different windows is achieved.

From the above description, the present invention provides a computer peripheral device for controlling scroll bars in different windows. The computer peripheral device comprises a plurality of scroll bar controlling units and a signal processing unit. These scroll bar controlling units are used for generating a scroll bar controlling signal. The signal processing unit is used for analyzing the scroll bar controlling signal. According to the scroll bar controlling signal, the scroll bars in different windows are correspondingly controlled.

The present also provides a method for controlling scroll bars in different windows. Firstly, the signal source of the scroll bar controlling signal is analyzed. By judging whether the signal source complies with a preset signal source, the signal processing unit will determine whether a window switching signal and the scroll bar controlling signal are simultaneously transmitted to the computer. Consequently, the scroll bar of the original window or another window may be controlled according to the requirements of the user. Then, the signal source is recorded. The signal source is set as the preset signal source, which is served as the analyzing sample of the next scroll bar controlling signal.

According to the design of the present invention, the speed of switching different windows is increased. If the word processing task is frequently performed by the user, the method of scrolling the scroll bars in different windows according to present invention is very convenient to the user. Since the time period of moving the cursor is saved, the working efficiency is largely enhanced. Moreover, since the need of moving the cursor is reduced, the possibility of causing the hand injury of the user will be largely reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A computer peripheral device for controlling scroll bars in different windows, said computer peripheral device comprising:
a plurality of scroll bar controlling units installed in said computer peripheral device, and comprising a first scroll bar controlling unit and a second scroll bar controlling unit for generating a scroll bar controlling signal; and
a signal processing unit for analyzing said scroll bar controlling signal, wherein if said scroll bar controlling signal is generated by said first scroll bar controlling unit, a scroll bar of a window is controlled according to said scroll bar controlling signal, wherein if said scroll bar controlling signal is generated by said second scroll bar controlling unit, a scroll bar of another window is controlled according to said scroll bar controlling signal.

2. The computer peripheral device according to claim 1 wherein said computer peripheral device is a mouse.

3. The computer peripheral device according to claim 1 wherein said first scroll bar controlling unit is a first wheel, and said second scroll bar controlling unit is a second wheel.

4. The computer peripheral device according to claim 1 wherein said first scroll bar controlling unit is a first sensing area, and said second scroll bar controlling unit is a second sensing area.

5. The computer peripheral device according to claim 4 wherein said first sensing area is disposed on a first touchpad, and said second sensing area is disposed on a second touchpad.

6. The computer peripheral device according to claim 4 wherein said first sensing area and said second sensing area are both disposed on a touchpad.

7. The computer peripheral device according to claim 6 wherein said scroll bar controlling signal contains a local information, and said local information of said scroll bar controlling signal is analyzed by said signal processing unit, wherein if said local information complies with a first local information corresponding to said first sensing area, said signal processing unit judges that said scroll bar controlling signal is generated by said first sensing area, wherein if said local information complies with a second local information corresponding to said second sensing area, said signal processing unit judges that said scroll bar controlling signal is generated by said second sensing area.

8. The computer peripheral device according to claim 7 wherein said local information is a coordinate.

9. The computer peripheral device according to claim 8 wherein said first local information is a first coordinate range, and said second local information is a second coordinate range.

10. The computer peripheral device according to claim 7 wherein said first sensing area and said second sensing area comprises a plurality of sensing units, wherein each of said sensing units has a sensing unit code, and said local information is said sensing unit code.

11. The computer peripheral device according to claim 10 wherein said first local information is a first sensing unit code range, and said second local information is a second sensing unit code range.

12. A method for controlling scroll bars in different windows by operating a computer peripheral device, said computer peripheral device comprising a plurality of scroll bar controlling units including a first scroll bar controlling unit and a second scroll bar controlling unit for generating a scroll bar controlling signal, said method comprising steps of:
(A) analyzing said scroll bar controlling signal, thereby realizing a signal source, wherein said signal source is one of said plurality of scroll bar controlling units;
(B) judging whether said signal source complies with a preset signal source or not, wherein if said signal source complies with said preset signal source, said scroll bar controlling signal is transmitted, wherein if said signal source does not comply with said preset signal source, a window switching signal and said scroll bar controlling signal are transmitted; and
(C) recording said signal source, and setting said signal source as said preset signal source.

13. The method according to claim 12 wherein said computer peripheral device is a mouse.

14. The method according to claim 12 wherein said preset signal source is said first scroll bar controlling unit.

15. The method according to claim 12 wherein said first scroll bar controlling unit is a first wheel, and said second scroll bar controlling unit is a second wheel.

16. The method according to claim 12 wherein said first scroll bar controlling unit is a first sensing area, and said second scroll bar controlling unit is a second sensing area.

17. The method according to claim 16 wherein said first sensing area is disposed on a first touchpad, and said second sensing area is disposed on a second touchpad.

18. The method according to claim 16 wherein said first sensing area and said second sensing area are both disposed on a touchpad.

19. The method according to claim 18 wherein in said step (A), said signal source is realized according to a local information of said scroll bar controlling signal, wherein if said local information complies with a first local information corresponding to said first sensing area, said signal processing unit judges that said scroll bar controlling signal is generated by said first sensing area, wherein if said local information complies with a second local information corresponding to said second sensing area, said signal processing unit judges that said scroll bar controlling signal is generated by said second sensing area.

20. The method according to claim 19 wherein said local information is a coordinate.

21. The method according to claim 20 wherein said first local information is a first coordinate range, and said second local information is a second coordinate range.

22. The method according to claim 19 wherein said first sensing area and said second sensing area comprises a plurality of sensing units, wherein each of said sensing units has a sensing unit code, and said local information is said sensing unit code.

23. The method according to claim 22 wherein said first local information is a first sensing unit code range, and said second local information is a second sensing unit code range.
